(19) United States
(12) Patent Application Publication
(10) Pub. No.: US 2024/0054093 A1
(43) Pub. Date: Feb. 15, 2024

(54) METHOD FOR PERFORMING DATA TRANSMISSION

(71) Applicant: Robert Bosch GmbH, Stuttgart (DE)

(72) Inventors: Andreas Enns, Kirchheim Am Neckar (DE); Daniele Ambrosio, Stuttgart (DE)

(21) Appl. No.: 18/334,809

(22) Filed: Jun. 14, 2023

(30) Foreign Application Priority Data
Aug. 11, 2022 (DE) 10 2022 208 383.0

(51) Int. Cl. G06F 13/42; G06F 13/40

(52) U.S. Cl. CPC G06F 13/42; G06F 13/4022

(57) ABSTRACT

A method for performing data transmission between a control device and an electronic unit. A control unit and a FlexRay transceiver are provided in the control device and a control unit and a FlexRay transceiver also being provided in the electronic unit. A FlexRay link is used as a physical route for data transmission and the data transmission is performed using the UART protocol.

### CROSS REFERENCE

The present application claims the benefit under 35 U.S.C. § 119 of German Patent Application No. DE 10 2022 208 383.0 filed on Aug. 11, 2022, which is expressly incorporated herein by reference in its entirety.

### FIELD

The present invention relates to a method for performing data transmission between a control device and an electronic unit, and to such a control device.

### BACKGROUND INFORMATION

Control devices are electronic modules that are used at various points in technical systems, such as motor vehicles, to control and/or regulate technical processes and components. A large number of control devices are installed in current motor vehicles, with at least some of these devices being subject to stringent requirements in terms of safety.

German Patent Application No. DE 10 2006 019 305 A1 describes a method for transmitting data to and from a control device, in particular an engine control device, which has a first communication interface and a second communication interface. In the method, the first communication interface is connected to a development tool and the second communication interface is connected to one or more functional units during the development phase of the control device.

It should be noted that modern control devices, in particular in motor vehicles, require ever larger memory elements, due to their ever increasing number of functions. For example, memory chips are used for programs and data. These memories must be programmed during the production process in the plants, during end-of-line programming by the vehicle manufacturers and possibly also in workshops in the field.

Thereby, data to be programmed may be sent via a serial interface to the control device, for example, which is otherwise used to transmit diagnostic information.

This means that during factory testing, when writing/programming the memory chips or in the return analysis, data must be exchanged with the installed control unit via existing communication channels of the control device, such as in a single-chip system (SoC: system-on-chip). These communication channels can consist of different bus systems, for example FlexRay.

A method for exchanging data between participants connected via a bus system is described in German Patent Application No. DE 10 2012 224 024 A1. In this case, data can be transmitted via UART or FlexRay.

Each of the bus systems used, in this case FlexRay, has its own protocol that must be implemented on both sides of the communication. This means that the test software with the associated protocol driver layers can only be used for one bus system at a time. The data rate is also specified by the relevant bus system.

German Patent No. DE 101 53 085 A1 describes a method for programming a control unit, wherein the control unit can be connected to an external programming unit via a communication interface. An internal communication link connects the communication interface to a control unit, which in turn has a programming element and a communication element. A switching means (i.e., a switch) is also provided, by means of which the communication link is switched between the programming element and the communication element. The communication link is a CAN (controller area network) link. A CAN driver circuit is connected in the communication link between the communication interface and the control unit.

### SUMMARY

According to the present invention, a method and a control device for performing data transmissions are provided. Example embodiments of the present invention are disclosed herein.

The method according to the present invention is used to perform data transmission between a control device and an electronic unit, a control unit and a FlexRay transceiver being provided in the control device and a control unit and a FlexRay transceiver also being provided in the electronic unit. For data transmission, a FlexRay link is used as a physical link, and data is transmitted using the UART protocol.

The physical route is given by the lowest layer of the OSI model. Data transmission typically takes place via a communication link, namely via the lines designated BP and BM on the FlexRay transceiver.

Thus, the method according to the present invention is used to perform data transmission between a control device and an electronic unit, with bidirectional data transmission being possible in this case. Data can thus be transmitted from the electronic unit to the control device. In addition, data can be transmitted from the control device to the electronic unit.

In an example embodiment of the present invention, the method, the corresponding protocols of the individual bus systems are thus omitted, and therefore only the physical transmission route is used. In this way, a uniform protocol, in particular ASC (asynchronous serial communication), can be used on all systems. This procedure is also referred to herein as ASC@FlexRay. Asynchronous serial communication refers to serial communication in which the interfaces of the communicating end points are not continuously synchronized by a common clock signal.

The method of the present invention makes it possible to omit the sometimes considerable overhead, for example by synchronizing the clock, the bus protocols and the provision of a restbus.

The term restbus refers primarily to a simulation of the control device network in the OEM's target system (passenger car). This is necessary to be able to drive and test the control device.

Since, with typical applications, there is only a point-to-point link, in particular in conjunction with a tester control device or a tester ECU (electronic control unit), i.e. between the control device and the electronic unit, for example a tester, both can be omitted. A synchronization of the clock is not necessary, since, on account of the transmission via UART protocol, synchronization takes place after each byte. An extremely simple transmission protocol, such as xKWP, with 4 bytes of overhead is sufficient to ensure error-free communication.

With the method according to an present invention, the following can be provided:

The FlexRay bus system with its associated hardware (transceiver) is only used as a physical route.

By omitting the bus system's own protocol and restbus, pure UART communication (ASC) can be used on this route.

By eliminating the bus's own timing constraints, significantly higher data rates are possible.

There are uniform code portions for all projects or customers within the projects, since the same protocol, such as CAN, FlexRay, or Ethernet, is always used regardless of the physical route.

Furthermore, it should be noted that all common FlexRay bus systems or their physical layers are considered as variants.

The control device according to the present invention is configured to perform a method of the type described herein. For this purpose, the control device regularly has a control unit and a FlexRay transceiver. Furthermore, it typically has a (communication) interface required for data transmission.

Further advantages and embodiments of the present invention can be found in the description and the figures.

Of course, the features mentioned above and those still to be explained below can be used not only in the respectively specified combinations, but also in other combinations or alone, without departing from the scope of the present invention.

### BRIEF DESCRIPTION OF THE DRAWINGS

FIG. 1 shows a block diagram of a control device together with an electronic unit for performing an example embodiment of the method according to the present invention.

FIG. 2 shows a transmission path from a microcontroller to a FlexRay transceiver.

FIG. 3 shows the time sequence of the data transmission according to an example embodiment of the method of the present invention.

### DETAILED DESCRIPTION OF EXAMPLE EMBODIMENTS

The present invention is represented schematically in the drawings on the basis of embodiments and is described in detail below with reference to the figures.

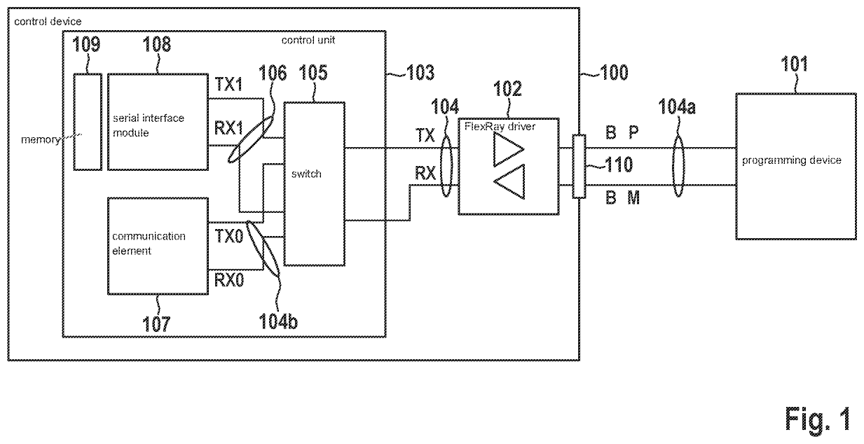

FIG. 1 shows a control device 100 and a programming device 101. The control device 100 has a communication interface 110 to the outside, to which a communication link 104 having the lines TX and RX is internally connected. A driver element, in particular a FlexRay driver 102, is connected in this communication link 104, i.e. the two lines TX and RX, which driver element makes a bidirectional link with the desired levels to the communication interface 110 possible. The external lines, i.e. the communication link 104a to the outside, are designated BP and BM. The programming device 101 is connectable to the control device 100 via this external communication link 104a.

A control unit 103, for example a microprocessor or microcomputer, is included in the control device 100. This comprises a communication element 107, which in this example corresponds to a FlexRay controller. Also included in the microprocessor 103 is a serial interface module 108, for example an asynchronous serial communication interface ASC, through which data for programming the memory 109, which in particular is also integrated in a control unit or a microprocessor, can be received or transmitted. Furthermore, communication can also be ensured via the interface module 108. In this case, the memory 109 can also be located outside the control unit 103 and is preferably in the form of a flash memory.

The illustration further shows a switching means (i.e., a switch) 105, in which, in particular, a program-controlled interface switch or multiplexer is provided to enable switching of the communication link from the communication element 107 to the interface module 108.

For all control devices with a control unit or SoCs that allow switching from FlexRay to UART SoC-internally on the pins TX0/RX0, the switching means 105 can be omitted. Then, switching takes place in the control device 100 with software, in the case shown for ASC@FlexRay. If the installed SoC does not allow UART and FlexRay to be switched, such a switching means 105 is required.

Within the framework of normal communication, in particular in the control device network in the vehicle, the link of the FlexRay controller 107 via communication link sections 104b, an interface switch in the switching means 105 and communication link 104 to the FlexRay driver 102 and to the FlexRay interface 110 is present, and a usual data transmission takes place within the framework of FlexRay communication, i.e. a first bus protocol, in particular the FlexRay bus protocol, is used here.

If the control device 100 is now intended to be programmed or communicated with in test mode, the control device 100 is connected to the programming device 101 via 104a for this purpose. The interface switch in the switching means 105 then contacts the link to element 108 via link section 106. Thus, the communication interface 110, the FlexRay driver 102 and the communication link 104 to the control unit 103 can also be used for programming or test mode communication. However, a second bus protocol, in particular a standard protocol of a serial interface, such as UART, is used here for programming.

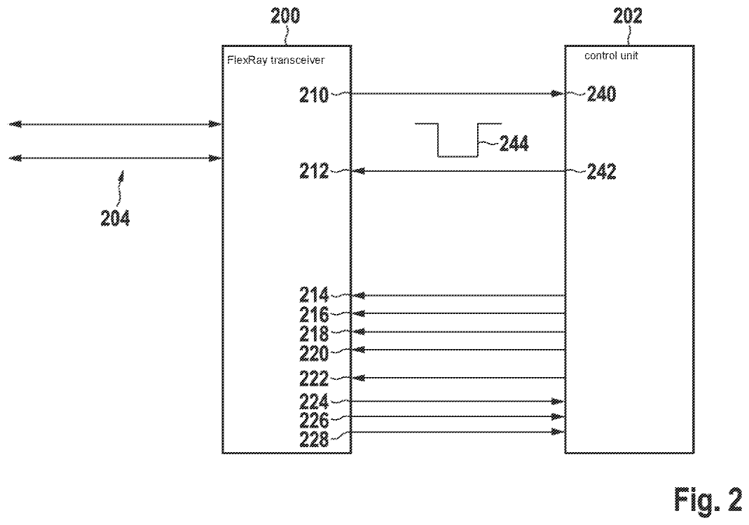

FIG. 2 shows a transmission path from a control unit to a FlexRay transceiver. The illustration shows a FlexRay transceiver 200 and a control unit 202, which transceiver is designed, for example, as a SoC (system-on-chip) or a SiP (system-in-package). The FlexRay transceiver 200 is connected to a FlexRay bus 204.

The FlexRay transceiver has pins: RxD 210, TxD 212, TXEN 214, BGE 216, STBN 218, EN 220, WAKE 222, RXEN 224, ERRN 226 and INH 228. The microcontroller 202 has pins UART_RXD 240 and UART_TXD 242 for a UART signal 244, along with pins corresponding to the pins 214 to 228 of the FlexRay transceiver 200.

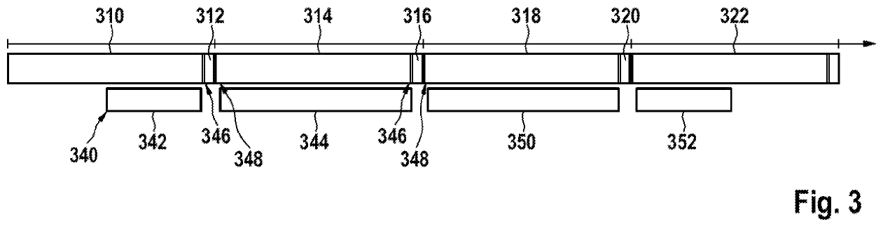

FIG. 3 shows the time sequence of the data transmission according to an embodiment of the presented method. An axis 300 illustrates the time sequence in ms. A first temporal range 310 covers 650 to 2600 μs, a second temporal range 312 covers 10 μs, a third temporal range covers 650 to 2600 μs, a fourth temporal range 316 covers 10 μs, a fifth temporal range 318 covers 650 to 2600 μs, a sixth temporal range 320 covers 10 μs and a seventh temporal range 322 covers 650 to 2600 μs. Continuous operation is provided such that this sequence continues.

FIG. 3 thus illustrates a continuous data stream that shows how data synchronization must be operated in software in order to enable appropriate communication. What happens at the software level is shown.

The time sequence is:

At a point in time 340, the transmission of a data block begins. x bytes are sent (reference number 342). N bytes are then sent (reference number 344). Arrows 346 indicate when the TX pin is configured as GPIO (general-purpose I/O). The TXEN pin and the TX pin are set to high and low, respectively. Arrows 348 indicate when the TX pin is configured. The TXEN pin is then set to low. (N-Y) bytes are sent (reference number 350) until the entire data block has been transmitted. The block 352 represents the remaining amount of data to be transmitted that could not be included in the previous block 350.

On the part of the tester and the control device (ECU), after the FlexRay bus transceivers, the controller is not configured to the corresponding bus system, but as a UART (see FIG. 2), wherein the so-called xKWP protocol is then used uniformly on all controllers.

A slim overhead of 4 bytes per message, which can have a maximum length of 16,000 bytes, indicates the extremely favorable ratio of overhead to user data of 0.25%.

It must be taken into account that, for communication with the xKWP protocol, the user data are preceded by 2-byte length information, and at the end 2-byte CRC-16, formed by length bytes and user data, is added. This is sufficient for secure communication, since transmission errors are reliably detected and the faulty message can be repeated. In order to send the user data of a maximum length of 16,375 bytes, it is necessary to ensure synchronization between TXD and TXEN. For this purpose, reference is made to FIG. 3.

Different errors and response messages for different situations, for example a “response pending” if the processing of the last command is still ongoing, are specified in ISO_14230-3.

In principle, the type of communication described here can be used on all control devices where data is exchanged via the route of a FlexRay bus system in production or return analysis.

What is claimed is:

1. A method for performing data transmission between a control device and an electronic unit, the method comprising:
providing a control unit and a FlexRay transceiver in the control device, and also providing a control unit and a FlexRay transceiver in the electronic unit; and
using a FlexRay link as a physical route for the data transmission, and performing the data transmission using a UART protocol.

2. The method as recited in claim 1, wherein the data transmission is used to program the control device.

3. The method as recited in claim 2, further comprising:
performing a switching between a communication element and an interface module using software or a switch.

4. The method as recited in claim 1, wherein the data transmission takes place via a communication link.

5. The method as recited in claim 1, wherein synchronization of pins TXD and TXEN is performed.

6. A control device which is configured to perform data transmission with an electronic unit, comprising:
a control unit and a FlexRay transceiver;
wherein the control device is configured to use a FlexRay link as a physical route for the data transmission, and to perform the data transmission using a UART protocol.

7. The control device as recited in claim 6, further comprising:
an interface module and a communication element, between which it is possible to switch.

8. The control device as recited in claim 7, wherein software that is configured to switch between the interface module and the communication element is stored in the control device.

9. The control device as recited in claim 7, further comprising a switching element configured to switch between the interface module and the communication element.
